(19) United States
(12) Patent Application Publication
(10) Pub. No.: US 2009/0142681 A1
(43) Pub. Date: Jun. 4, 2009

(54) Pigment Preparations Based on Diketopyrrolopyrroles

(76) Inventors: Tanja Reipen, Mainz (DE); Carsten Plueg, Muehltal/Niederbeerbach (DE); Joachim Weber, Reinach (CH)

Correspondence Address: CLARIANT CORPORATION;INTELLECTUAL PROPERTY DEPARTMENT, 4000 MONROE ROAD, CHARLOTTE, NC, 28205, US

(21) Appl. No.: 12/083,892

(22) PCT Filed: Sep. 12, 2006
(86) PCT No.: PCT/EP2006/008866

§ 371 Date: May 21, 2008

(30) Foreign Application Priority Data
Oct. 21, 2005 (DE) 10 2005 050 512.0

(51) Int. Cl. G03G 9/00; C08K 5/42; G02B 5/23; C09D 11/02

(52) U.S. Cl. 430/108.2; 106/503; 252/586; 106/31.65; 524/157

(57) ABSTRACT

The invention relates to a pigment preparation, characterized in that it contains C.I. Pigment Red 254 with an average particle size of 20 to 100 nm and at least one pigment dispersant of the formula (II) or (III). In said formulaes, Q², s, n, R³, R⁴, E⁺ and G⁺ are as defined in the specification. A represents a bivalent group —O—, —NR³—, —NR¹⁶— SO₃⁻G⁺, B represents a bivalent group —NR¹⁶—SO₃⁻G⁺ and Q represents an organic pigment group, selected from the group consisting of C.I. Pigment Red 264 and C.I. Pigment Violet 19.

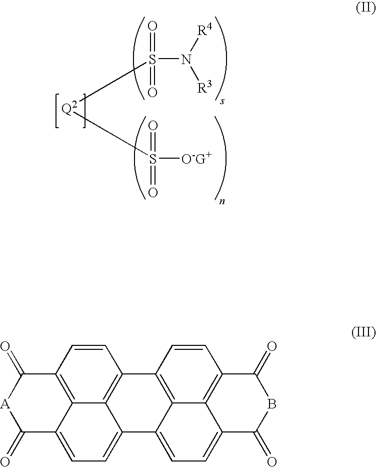

The present invention relates to new pigment preparations comprising C.I. Pigment Red 254 as base pigment and certain pigment dispersants which are anionic or contain amine groups.

Pigment preparations are combinations of base pigments and what are called pigment dispersants, which are pigments substituted by groups having specific activity. The pigment dispersants are added to the pigments in order to facilitate their dispersion in the application media, in particular in paints and inks, including printing inks, and to enhance the rheological and coloristic properties of the pigments. By this means it is possible to achieve an increase in, for example, the color strength, the transparency, and the gloss in numerous applications.

Color filters are produced using particularly finely divided pigments in order largely to rule out particle scattering, which leads to a reduction in the contrast ratio.

WO 01/04215 discloses a finely divided diketopyrrolopyrrole pigment, C.I. Pigment Red 254 (I),

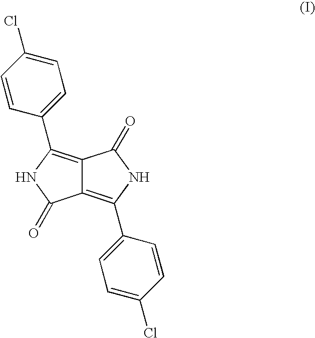

which is characterized by a particularly narrow particle size distribution in conjunction with high crystallinity and specific absorption characteristics. A C.I. Pigment Red 254 of this kind can be obtained by first stirring a crude pigment with an inorganic salt under dry conditions at least 80° C. and then subjecting the product to a kneading operation with inorganic salts in the presence of organic solvents.

On the basis of this known process, commercial products are available and are recommended for applications in which there is a need for high transparency, such as in color filters. These pigments, however, do not always satisfy all of the requirements of the art. In particular there has been a need for improvement in terms of transparency, dispersibility, and rheology.

EP-A-1 104 789 describes pigment dispersants based on pigments, such as on diketopyrrolopyrroles or quinacridones, for example.

The object was to provide pigment preparations comprising C.I. Pigment Red 254 as base pigment that exhibit high color strength, low viscosity, and extremely low deviation in shade from the C.I. Pigment Red 254 base pigment, and which are suitable in particular for color filter applications.

It has been found that pigment preparations based on C.I. Pigment Red 254 having a defined particle size, and on the pigment dispersants defined below, achieve this object, although on the basis of the coloristics of the individual compounds a much greater deviation in shade would have been expected.

The invention provides pigment preparations comprising C.I. Pigment Red 254 having an average particle size d₅₀ of 20 to 100 nm and at least one pigment dispersant of the formula (II) and/or (III)

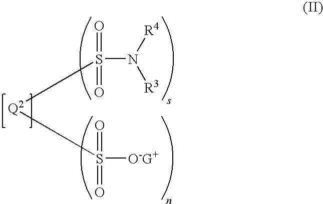

in which
Q² is the radical of an organic pigment selected from the group of C.I. Pigment Red 264 and C.I. Pigment Violet 19;
s is a number from 1 to 5, preferably 1 to 3;
n is a number from 0 to 4, preferably 0 to 2; the sum of s and n being 1 to 5;
R³ is a branched or unbranched, saturated or unsaturated, aliphatic hydrocarbon radical having 1 to 20 carbon atoms, or is a C₅-C₇ cycloalkylene radical, or is an araliphatic or aromatic radical having 1, 2 or 3 aromatic rings, it being possible for the rings to be fused or to be linked by a bond, or is a heterocyclic radical having 1, 2 or 3 rings containing 1, 2, 3 or 4 heteroatoms from the group O, N and S, or a combination thereof; the stated hydrocarbon, cycloalkylene, aromatic, araliphatic, and heteroaromatic radicals may be substituted by 1, 2, 3 or 4 substituents from the group of OH, CN, F, Cl, Br, NO₂, CF₃, C₁-C₆ alkoxy, S—C₁-C₆ alkyl, NHCONH₂, NHC(NH)NH₂, NHCO—C₁-C₆ alkyl, C₁-C₆ alkyl, COOR⁵, CONR⁵R⁶, NR⁵R⁶, SO₃R⁵ or SO₂—NR⁵R⁶, with R⁵ and R⁶ being alike or different and being hydrogen, phenyl or C₁-C₆ alkyl;
R⁴ is hydrogen, R³ or C₁-C₆ alkyl-COO⁻E⁺;
E⁺, G⁺ independently of one another are H⁺ or the equivalent M^{p+}/m of a metal cation M^{p+} from main group 1 to 5 or from transition group 1 or 2 or 4 to 8 of the Periodic Table of the Elements, m being one of the numbers 1, 2 or 3 and p being the number 1, 2 or 3; or is a substituted or unsubstituted ammonium ion;

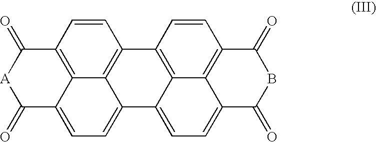

in which
A is a divalent radical —O—, —NR³—, —NR¹⁶—SO₃⁻G⁺,
B is a divalent radical —NR¹⁶—SO₃⁻G⁺,
   R¹⁶ being a linear or branched C₁-C₆ alkylene chain and R³ and G⁺ being as defined above.

In preferred pigment dispersants of the formula (II)
R³ is C₁-C₆ alkyl, benzyl or phenyl,
R⁴ is hydrogen, C₁-C₆ alkyl, benzyl, phenyl or C₁-C₆ alkyl-COO⁻E⁺,
E⁺, G⁺ are hydrogen or an alkali metal, especially Li, Na or K.

In preferred pigment dispersants of the formula (III)
A is a divalent radical —NR³ and
B has the preferred definitions above,
G⁺ is hydrogen or an alkali metal, especially Li, Na or K.

Where E⁺ and G⁺ are an ammonium ion the following are suitable:

(i) NR⁷R⁸R⁹R¹⁰, the substituents R⁷, R⁸, R⁹ and R¹⁰ independently of one another each being a hydrogen atom, C₁-C₃₀ alkyl, C₂-C₃₀ alkenyl, C₅-C₃₀ cycloalkyl, phenyl, (C₁-C₈)alkyl-phenyl, (C₁-C₄)alkylene-phenyl, or a (poly)alkyleneoxy group of the formula —[CH(R¹¹)—CH(R¹¹)—O]ₖ—H, in which k is a number from 1 to 30 and the two radicals R¹¹ independently of one another are hydrogen, C₁-C₄ alkyl or, if k>1, a combination thereof;
and in which alkyl, alkenyl, cycloalkyl, phenyl or alkylphenyl identified as R⁷, R⁸, R⁹ and/or R¹⁰ may be substituted by amino, hydroxyl, and/or carboxyl;
or where the substituents R⁷ and R⁸ together with the quaternary N atom may form a five-membered to seven-membered saturated ring system, which if desired also contains further heteroatoms from the group of O, S and N;
or where the substituents R⁷, R⁸ and R⁹ together with the quaternary N atom may form a five-membered to seven-membered aromatic ring system, which if desired also contains further heteroatoms from the group of O, S and N, and to which, if desired, additional rings are fused on;
or
(ii) an ammonium ion of the formula (IIIa),

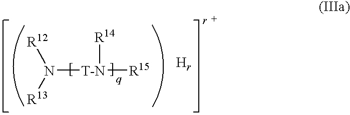

in which
R¹², R¹³, R¹⁴ and R¹⁵ independently of one another are hydrogen or a (poly)alkyleneoxy group of the formula —[CH(R¹¹)—CH(R¹¹)O]ₖ—H, in which k and R¹¹ are as defined above;
q is a number from 1 to 10;
r is a number from 1 to 5, where r≦q+1;
T is a branched or unbranched C₂-C₆ alkylene radical; or in which T, if q>1, can also be a combination of branched or unbranched C₂-C₆ alkylene radicals.

The pigment dispersants of the formula (II) are compounds known per se and can be prepared by known processes, in accordance for example with EP-A-1 104 789 or WO 02/064680.

The pigment dispersants of the formula (III) are compounds known per se and can be prepared by known processes, in accordance for example with EP-A-0 486 531.

In the pigment preparations of the invention the weight ratio of C.I. Pigment Red 254 to pigment dispersant of the formula (II) and/or (III) is preferably between (99.9:0.1) and (80:20), more preferably between (99:1) and (89:11), in particular between (98:2) and (90:10), and with very particular preference between (97:3) and (92:8).

For a mixture of the components C.I. Pigment Red 254 and the pigment dispersant of the invention in the claimed proportion, a deviation of ΔH and ΔC of in each case greater than 3.0 would be expected.

Surprisingly, however, it has been found that a coloration in accordance with DIN EN ISO 787-26 with ⅓ standard depth of color in the alkyd/melamine resin varnish system with a pigment preparation of the invention, in comparison to a coloration of the corresponding diketopyrrolopyrrole at ⅓ standard color depth and identical particle size, exhibits a ΔH (according to CIELAB) of preferably not more than 2.0, in particular not more than 1.5, and more preferably not more than 1.0. Preferably the ΔC (according to CIELAB) is not greater than 2.0, in particular not greater than 1.5, and more preferably not greater than 1.0. Chroma (C) is the parameter describing the coloredness of the color for a given lightness; ΔC describes the difference in the coloredness of two colors. Similarly, ΔH describes the difference in hue for two colors under comparison.

The pigment preparations of the invention are preferably of high crystallinity, characterized by a main-peak width at half peak height of 0.2 to 0.7° 2theta, in particular of 0.3 to 0.5° 2theta, in the X-ray powder diffractogram with CuKₐₗₚₕₐ radiation.

The pigment preparations of the invention comprise the base pigment with an average particle size d₅₀ of 20 to 100 nm, preferably 30 to 80 nm. The particle size distribution of C.I. Pigment Red 254 is preferably approximate to a Gaussian distribution, in which the standard deviation σ is preferably less than 40 nm, more preferably less than 30 nm. In general, the standard deviations are between 5 and 40 nm, preferably between 10 and 30 nm.

The pigment preparations of the invention surprisingly have a very low viscosity, preferably a viscosity of 3 to 50 mPas, measured at 20° C. using a cone-and-plate viscometer, such as the RS75 from Haake.

Besides the diketopyrrolopyrrole pigment and the pigment dispersant, the pigment preparations of the invention may comprise further, customary auxiliaries or additives, such as, for example, surfactants, dispersants, fillers, standardizers, resins, waxes, defoamers, antidust agents, extenders, antistatics, preservatives, drying retardants, wetting agents, antioxidants, UV absorbers, and light stabilizers, preferably in an amount of 0.1% to 10% by weight, in particular 0.5% to 5% by weight, based on the total weight of the pigment preparation.

Suitable surfactants include anionic, or anion-active, cationic, or cation-active, and nonionic or amphoteric substances, or mixtures of these agents.

Examples of suitable anionic substances include fatty acid taurides, fatty acid N-methyltaurides, fatty acid isethionates, alkylphenylsulfonates, an example being dodecylbenzenesulfonic acid, alkylnaphthalenesulfonates, alkylphenol polyglycol ether sulfates, fatty alcohol polyglycol ether sulfates, fatty acid amide polyglycol ether sulfates, alkylsulfosuccinamates, alkenylsuccinic monoesters, fatty alcohol polyglycol ether sulfosuccinates, alkanesulfonates, fatty acid glutamates, alkylsulfosuccinates, fatty acid sarcosides; fatty acids, examples being palmitic, stearic and oleic acid; the salts of these anionic substances and soaps, examples being alkali metal salts of fatty acids, naphthenic acids and resin acids, abietic acid for example, alkali-soluble resins, rosin-modified maleate resins for example, and condensation products based on cyanuric chloride, taurine, N,N′-diethylaminopropylamine and p-phenylenedia-mine. Preference is given to resin soaps, i.e., alkali metal salts of resin acids. Examples of suitable cationic substances include quaternary ammonium salts, fatty amine oxalkylates, polyoxyalkyleneamines, oxalkylated polyamines, fatty amine polyglycol ethers, primary, secondary or tertiary amines, examples being alkylamines, cycloalkylamines or cyclized alkylamines, especially fatty amines, diamines and polyamines derived from fatty amines or fatty alcohols, and the oxalkylates of said amines, imidazolines derived from fatty acids, polyaminoamido or polyamino compounds or resins having an amine index of between 100 and 800 mg of KOH per g of the polyaminoamido or polyamino compound, and salts of these cationic substances, such as acetates or chlorides, for example.

Examples of suitable nonionic and amphoteric substances include fatty amine carboxyglycinates, amine oxides, fatty alcohol polyglycol ethers, fatty acid polyglycol esters, betaines, such as fatty acid amide N-propyl betaines, phosphoric esters of aliphatic and aromatic alcohols, fatty alcohols or fatty alcohol polyglycol ethers, fatty acid amide ethoxylates, fatty alcohol-alkylene oxide adducts, and alkylphenyl polyglycol ethers.

By nonpigmentary dispersants are meant substances which structurally are not derived from organic pigments. They are added as dispersants either during the actual preparation of pigments, but often, also, during the incorporation of the pigments into the application media that are to be colored: for example, during the production of color filters, by dispersing the pigments into the corresponding binders. They may be polymeric substances, examples being polyolefins, polyesters, polyethers, polyamides, polyimines, polyacrylates, polyisocyanates, block copolymers thereof, copolymers of the corresponding monomers, or polymers of one class modified with a few monomers from a different class. These polymeric substances carry polar anchor groups such as, for example, hydroxyl, amino, imino and ammonium groups, carboxylic acid and carboxylate groups, sulfonic acid and sulfonate groups or phosphonic acid and phosphonate groups, and may also have been modified with aromatic, nonpigmentary substances. Nonpigmentary dispersants may additionally also be aromatic substances modified chemically with functional groups and not derived from organic pigments. Nonpigmentary dispersants of this kind are known to the skilled worker and in some cases are available commercially (e.g., Solsperse®, Avecia; Disperbyk®, Byk-Chemie; Efka®, Efka). A number of types will be named below, by way of representation, although in principle any desired other substances described can be employed, examples being condensation products of isocyanates and alcohols, diols or polyols, amino alcohols or diamines or polyamines, polymers of hydroxycarboxylic acids, copolymers of olefin monomers or vinyl monomers and ethylenically unsaturated carboxylic acids and carboxylic esters, urethane-containing polymers of ethylenically unsaturated monomers, urethane-modified polyesters, condensation products based on cyanuric halides, polymers containing nitroxyl compounds, polyester amides, modified polyamides, modified acrylic polymers, dispersants with a comblike structure comprising polyesters and acrylic polymers, phosphoric esters, triazine-derived polymers, modified polyethers, or dispersants derived from aromatic, nonpigmentary substances. These parent structures are in many cases modified further, by means for example of chemical reaction with further substances carrying functional groups, or by means of salt formation.

The pigment preparation of the invention can be employed as a preferably aqueous presscake or as moist granules, but generally comprises solid systems of pulverulent nature.

The invention also provides a process for preparing a pigment preparation of the invention, which comprises admixing C.I. Pigment Red 254 with the pigment dispersant of the formula (II) and/or (III) before or during an operation of kneading, wet grinding, dry grinding or finishing.

For example, the dry components in granule or powder form can be mixed before or after any grinding; one component can be added to the other component in moist or dry form, for example by mixing the components in the form of the moist presscakes. Mixing can be accomplished for example, by grinding in dry form, in moist form, by kneading for example, or in suspension, or by a combination of these methods. Grinding may be carried out with the addition of water, solvents, acids or grinding assistants such as salt.

Mixing can also be accomplished by adding the pigment dispersant during the operation of preparing the C.I. Pigment Red 254.

The pigment dispersant is added to the C.I. Pigment Red 254, though, preferably after the C.I. Pigment Red 254 has been formed, chemically, and before or during the formation of fine particles.

With particular preference the pigment dispersant is added to the diketopyrrolopyrrole pigment during an operation of dry or wet grinding. The finely crystalline pigment preparation formed in the course of grinding can be subjected to an aftertreatment, generally referred to as a finish, in water and/or solvents, for example, and generally at elevated temperature, up to 200° C. for example, and, if desired, elevated pressure. The pigment dispersant can also be added after dry or wet grinding but before or during finishing. The pigment dispersant can of course also be added in portions at different times.

The drying of a moist pigment preparation may be carried out using the known drying assemblies, such as drying ovens, bucket-wheel dryers, tumble dryers, contact dryers, and, in particular, spin flash dryers and spray dryers.

The pigment preparations of the invention are notable for their outstanding coloristic and rheological properties, in particular high flocculation stability, ready dispersibility, good rheology, high color strength, transparency, and saturation (chroma). In numerous application media they are dispersible readily with up to high levels of fineness. Pigment dispersions of this kind exhibit outstanding rheological properties even when the paint or printing-ink concentrates are highly pigmented. Other properties as well, such as gloss, fastness to overcoating, solvent fastness, alkali and acid fastness, light and weather fastnesses, and high purity of hue, are very good. Moreover, the pigment preparations of the invention can be used to obtain hues in the red range which are in demand for use in color filters. In that application they provide high contrast and also satisfy the other requirements posed in the context of using color filters, such as high temperature stability or steep and narrow absorption bands. They can be prepared with high purity and low ion content.

The pigment preparations of the invention can be employed in principle for pigmenting all high molecular mass organic materials of natural or synthetic origin, such as plastics, resins, varnishes, paints, electrophotographic toners and developers, electret materials, color filters, and inks, including printing inks, for example.

High molecular mass organic materials which can be pigmented with the pigment preparations of the invention are, for example, cellulose compounds, such as, for example, cellulose ethers and cellulose esters, such as ethylcellulose, nitrocellulose, cellulose acetates or cellulose butyrates, natural binders, such as, for example, fatty acids, fatty oils, resins and their conversion products or synthetic resins, such as polycondensates, polyadducts, addition polymers and copolymers, such as, for example, amino resins, especially urea and melamine formaldehyde resins, alkyd resins, acrylic resins, phenoplasts and phenolic resins, such as novolaks or resols, urea resins, polyvinyls, such as polyvinyl alcohols, polyvinyl acetals, polyvinyl acetates or polyvinyl ethers, polycarbonates, polyolefins, such as polystyrene, polyvinyl chloride, polyethylene or polypropylene, poly(meth)acrylates and copolymers thereof, such as polyacrylic esters or polyacrylonitriles, polyamides, polyesters, polyurethanes, coumarone-indene and hydrocarbon resins, epoxy resins, unsaturated synthetic resins (polyesters, acrylates) with the different cure mechanisms, waxes, aldehyde and ketone resins, gum, rubber and its derivatives and latices, casein, silicones and silicone resins; individually or in mixtures.

It is unimportant whether the aforementioned high molecular mass organic compounds are present in the form of plastic masses or melts or in the form of spinning solutions, dispersions, varnishes, paints or printing inks. Depending on the intended use it proves advantageous to utilize the pigment preparations of the invention in the form of a blend or in the form of prepared products or dispersions.

It is also possible only to prepare the pigment preparation at the time of incorporation into the high molecular mass organic medium.

The present invention consequently further provides a high molecular mass organic material comprising a coloristically effective amount of a pigment preparation of the invention.

Based on the high molecular mass organic material it is intended to pigment, the pigment preparation of the invention is employed usually in an amount of 0.01% to 30% by weight, preferably 0.1% to 20% by weight.

The pigment preparations of the invention are also suitable for use as colorants in electrophotographic toners and developers, such as, for example, one- or two-component powder toners (also called one- or two-component developers), magnetic toners, liquid toners, polymerization toners, and specialty toners.

Typical toner binders are addition-polymerization resins, polyaddition resins and polycondensation resins, such as styrene, styrene-acrylate, styrene-butadiene, acrylate, polyester, phenolic-epoxy resins, polysulfones, polyurethanes, individually or in combination, and also polyethylene and polypropylene, which may also include further ingredients, such as charge control agents, waxes or flow assistants, or may be modified subsequently with these added ingredients.

The pigment preparations of the invention are additionally suitable for use as colorants in powders and powder coating materials, particularly in triboelectrically or electrokinetically sprayable powder coating materials which are employed to coat the surfaces of articles made, for example, from metal, wood, plastic, glass, ceramic, concrete, textile material, paper or rubber.

Moreover the pigment preparations of the invention are suitable for use as colorants in ink-jet inks on both an aqueous and a nonaqueous basis, and also in inks which operate in accordance with the hot-melt process.

Ink-jet inks generally contain a total of 0.5% to 15% by weight, preferably 1.5% to 8% by weight (reckoned on a dry basis), of one or more of the pigment preparations of the invention.

Microemulsion inks are based on organic solvents, water, and, where appropriate, an additional hydrotropic substance (interface mediator).

Microemulsion inks contain generally 0.5% to 15% by weight, preferably 1.5% to 8% by weight, of one or more of the pigment preparations of the invention, 5% to 99% by weight of water, and 0.5% to 94.5% by weight of organic solvent and/or hydrotropic compound.

“Solvent-based” ink-jet inks contain preferably 0.5% to 15% by weight of one or more of the pigment preparations of the invention, 85% to 99.5% by weight of organic solvent and/or hydrotropic compounds.

Hot-melt inks are based usually on waxes, fatty acids, fatty alcohols or sulfonamides which are solid at room temperature and liquefy on heating, the preferred melting range being between about 60° C. and about 140° C. Hot-melt ink-jet inks are composed, for example, essentially of 20% to 90% by weight of wax and 1% to 10% by weight of one or more of the pigment preparations of the invention. They may further include 0 to 20% by weight of an additional polymer (as “dye dissolver”), 0 to 5% by weight of dispersing assistant, 0 to 20% by weight of viscosity modifier, 0 to 20% by weight of plasticizer, 0 to 10% by weight of tack additive, 0 to 10% by weight of transparency stabilizer (which prevents, for example, crystallization of the waxes), and 0 to 2% by weight of antioxidant.

Particularly the pigment preparations of the invention are also suitable for use as colorants for color filters, both for additive and for subtractive color generation, such as, for example, in electrooptical systems such as television screens, LCDs (liquid crystal displays), charge-coupled devices, plasma displays or electroluminescent displays, which may in turn be active (twisted nematic) or passive (supertwisted nematic) ferroelectric displays or light-emitting diodes, and also as colorants for electronic inks (or e-inks) or electronic paper (e-paper).

In the production of color filters, both reflective and transparent color filters, pigments are applied in the form of a paste or as pigmented photoresists in suitable binders (acrylates, acrylic esters, polyimides, polyvinyl alcohols, epoxides, polyesters, melamines, gelatins, caseins) to the respective LCD components (e.g., TFT-LCD=Thin Film Transistor Liquid Crystal Displays or, e.g., (S) TN-LCD=(Super) Twisted Nematic-LCD). Besides high thermal stability, high pigment purity is a prerequisite for a stable paste and/or a pigmented photoresist. Furthermore, the pigmented color filters can also be applied by ink-jet printing processes or other suitable printing processes.

The red hues of the pigment preparations of the invention are especially suitable for the color filter color set red-green-blue (R.G.B). These three colors are present as separate color points alongside one another, and when backlit produce a full-color image.

Typical colorants for the red color point are pyrrolopyrrole, quinacridone and azo pigments, such as C.I. Pigment Red 254, C.I. Pigment Red 209, C.I. Pigment Red 175 and C.I. Pigment Orange 38, for example, individually or mixed. For the green color point, phthalocyanine colorants are typically employed, such as C.I. Pigment Green 36 and C.I. Pigment Green 7, for example.

As and when required, the respective color points may also be admixed with further colors for the purpose of shading. For the red and green hue it is preferred to carry out blending with yellow, as for example with C.I. Pigment Yellow 138, 139, 150, 151, 180 and 213.

In the examples which follow, parts and percentages are by weight unless indicated otherwise.

The coloristic properties were determined in accordance with DIN 55986. The viscosity was determined by dispersing a 10% suspension of the pigment preparation in PGMEA (propylene glycol monomethyl ether acetate) in the presence of a commercially customary, high molecular mass block copolymer in the Paintshaker Disperse DAS 200 from Lau GmbH. The resulting millbase is subjected to measurement at 20° C. using a Haake RS75 cone-and-plate viscometer.

### EXAMPLE 1

### Bead Milling of C.I. Pigment Red 254 in the Presence of a DPP-Based Pigment Dispersant

A mixture of 10 g of P.R. 254, 360 g of zirconium mixed oxide beads (0.3-0.4 mm), 90 g of water and 0.5 g of a pigment dispersant of the formula (IV),

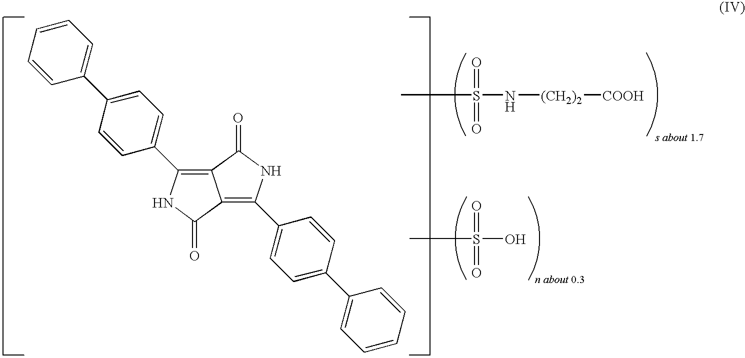

prepared in accordance with example 1a from EP-A-1 362 081 is ground in a Drais® PML mill for 15 minutes. The millbase is separated from the beads and filtered, and the filtercake is heated at reflux for 5 hours with a 1:1 mixture of water and isobutanol at a pH of 7 in the presence of phosphate buffer; following steam distillation, the mixture is filtered, and the solid product is washed phosphate-free with water, dried under reduced pressure and, finally, pulverized. This gives 8.3 g of a red pigment preparation having an average particle size of 63 nm (TEM).

### EXAMPLE 2

### Bead Milling of C.I. Pigment Red 254 with Flow Improver and Addition of a DPP-Based Pigment Dispersant Prior to Solvent Treatment

A mixture of 2564 g of a water-moist filtercake of P.R. 254 (39%) and 100 g of a commercially customary flow improver based on naphthalene sulfonic acid is converted to a homogeneous paste and ground using a Drais® Super Flow mill in the presence of 2190 g of zirconium mixed oxide beads (0.3-0.4 mm), the pigment concentration being adjusted to 10% by gradual addition of water. The duration of grinding corresponds to two to three theoretical grinding passes. The grinding suspension is admixed with 50 g of a pigment dispersant, prepared in the same way as for example 1a from EP-A-1 362 081, and isobutanol, thus giving a 1:1 mixture of isobutanol and water. The suspension is heated at reflux for 2 hours at a pH of 7 in the presence of a phosphate buffer; after the isobutanol has been separated off by steam distillation, the mixture is filtered and the solid product is washed phosphate-free with water, dried under reduced pressure and, finally, pulverized. This gives 850 g of a red pigment preparation having an average particle size of 54 nm.

### EXAMPLE 3

### Bead Milling of C.I. Pigment Red 254 in the Presence of a Perylene-Based Pigment Dispersant

A mixture of 10 g of P.R. 254, 360 g of zirconium mixed oxide beads (0.3-0.4 mm), 90 g of water and 0.5 g of a pigment dispersant, prepared in the same way as for example 3 of EP-A-486 531, is ground for 15 minutes in a Drais® PML mill. The millbase is separated from the beads and filtered, and the filtercake is heated at reflux for 5 hours with a 1:1 mixture of water and isobutanol at a pH of 7 in the presence of phosphate buffer; following steam distillation, the mixture is filtered and the solid product is washed phosphate-free with water, dried under reduced pressure and, finally, pulverized. This gives 9.2 g of a red pigment preparation having an average particle size of 97 nm.

### EXAMPLE 4

### Dry Grinding of C.I. Pigment Red 254 in the Presence of DPP-Based Pigment Dispersants

A mixture of 15 g of P.R. 254, 0.75 g of a pigment dispersant, prepared in the same way as for example 10a from EP 1 104 789, 75 g of sodium sulfate and 700 g of Cylpebs® is ground in a vibrating mill for 8 hours. The mixture is stirred into 300 ml of water, acidified with sulfuric acid, stirred at 60° C. for 1 hour and filtered and the filtercake is washed to neutrality with water. The filtercake is heated at reflux for 5 hours with a 1:1 mixture of water and isobutanol at a pH of 7 in the presence of phosphate buffer and 0.75 g of a pigment dispersant prepared according to example 1a from EP-A-1 362 081; following steam distillation it is filtered and the solid product is washed phosphate-free with water, dried under reduced pressure and, finally, pulverized. This gives 14.6 g of a red pigment preparation having an average particle size of 40 nm (TEM).

### EXAMPLE 5

### Salt Kneading of C.I. Pigment Red 254 in the Presence of a DPP-Based Pigment Dispersant

A mixture of 15 g of P.R. 254, 0.75 g of a pigment dispersant, prepared in the same way as for example 1a from EP 1 362 081, 90 g of microcrystalline sodium chloride and 15 g of diethylene glycol is kneaded on a 0.3 liter type De 034 s kneader from Stephan Werke Hameln at 100-105° C. for 16 hours. The kneading compound is stirred in 200 ml of hydrochloric acid (5%) at 90° C. for 2 hours and the solid is isolated by filtration, washed to neutrality with water and dried. This gives 15 g of a red pigment preparation having an average particle size of 48 nm.

### COMPARATIVE EXAMPLE A

### Bead Milling of C.I. Pigment Red 254 in the Presence of a Flow Improver without a Pigment Dispersant

A mixture of 2564 g of a water-moist filtercake of P.R. 254 (39%) and 100 g of a commercially customary flow improver based on naphthalene sulfonic acid is converted to a homogeneous paste and ground using a Drais® Super Flow mill in the presence of 2190 g of zirconium mixed oxide beads (0.3-0.4 mm), the pigment concentration being adjusted to 10% by gradual addition of water. The duration of grinding corresponds to two to three theoretical grinding passes. The grinding suspension is admixed with isobutanol, thus giving a 1:1 mixture of isobutanol and water. The suspension is heated at reflux for 2 hours at a pH of 7 in the presence of a phosphate buffer; after the isobutanol has been separated off by steam distillation, the mixture is filtered and the solid product is washed phosphate-free with water, dried under reduced pressure and, finally, pulverized. This gives 800 g of a red pigment having an average particle size of 100 nm (TEM).

### COMPARATIVE EXAMPLE B

### Dry Grinding of C.I. Pigment Red 254 without Pigment Dispersant

Grinding is carried out in the same way as for example 4 with 20 g of P.R. 254, but without addition of pigment dispersants. This gives 17.8 g of a red pigment having an average particle size of 125 nm.

TABLE 1
Particle size distribution and standard deviation

| Sample | d50 [nm] | Standard deviation σ [nm] |
|---|---|---|
| Example 1 | 63 | 20 |
| Example 2 | 54 | 26 |
| Example 3 | 97 | 52 |
| Example 4 | 40 | 11 |
| Example 5 | 48 | 38 |
| Comparative example A | 100 | 39 |
| Comparative example B | 125 | 41 |

For the particle size distribution a series of electron micrographs is used. The primary particles are identified visually. The area of each primary particle is determined by means of a graphics tablet. From the area, the diameter of the circle of equal area is determined. The frequency distribution of the equivalent diameters thus calculated is determined, and the frequencies are converted to volume fractions and expressed as particle size distribution.

The standard deviation is a measure of the breadth of the distribution. The smaller the standard deviation, the narrower the particle size distribution.

TABLE 2
Crystallinity

| | Value at half peak height [°2θ] |
|---|---|
| Sample | (main peak) |
| Example 1 | 0.405 |
| Example 2 | 0.430 |
| Example 3 | 0.367 |
| Example 4 | 0.462 |
| Example 5 | 0.537 |

By value at half peak height is meant the width of the reflection at half peak height (half of the maximum) of the largest peak in each case (at 28°).

The value at half peak height for the samples is measured using a STOE/⊖ diffractometer (Cu—K_{α}, U=40 kV, I=40 mA) (slits: primary side/vertical 2×8 mm, primary side/horizontal 1.0 mm, secondary side 0.5 mm). The sample holder used is a standard steel holder. The measuring time is adapted to the desired statistical reliability, the angular range 2⊖ in the overview measurement is 5-30°, and the step width is 0.02° with a time period of 3 s. In the specialty range, measurement is carried out from 23-30° with a step width of 0.02° and a time period of 6 s.

The X-ray beam is monochromated by a graphite secondary monochromator and subjected to measurement with a scintillation counter, with continuous sample rotation. For the purpose of evaluation, a profile fit is carried out over the entire angular range of the second measurement 2⊖=23-30° (fit function: Lorentz² (4 reflections)).

Viscosity of a millbase for color filter applications:

10 g of pigment or pigment preparation from the above-described examples are suspended in 73 g of PGMEA (propylene glycol monomethyl ether acetate), admixed with 17 g of a commercially customary, high molecular mass block copolymer and 250 g of zirconium oxide beads (0.3 mm), and dispersed for three hours in the Paintshaker Disperse DAS 200 from Lau GmbH.

The millbase viscosity is determined using a Haake RS75 cone-and-plate viscometer at 20° C.

| | | Viscosity |
|---|---|---|
| Sample | Addition of dispersant during bead milling | [mPas] |
| Example 1 | 5% dispersant | 14 |
| Example 2 | 10% dispersant prior to finish | 11 |
| Example 3 | 5% dispersant | 9 |
| Example 4 | 5% dispersant each during grinding and during | 17 |
| | finish | |
| Comparative | No dispersant | 94 |
| example A | | |
| Comparative | No dispersant | 77 |
| example B | | |

The pigment preparations described are applied using a spincoater (POLOS Wafer Spinner) to glass plates (SCHOTT, laser-cut, 10×10 cm). Because of the low viscosities, bright, highly transparent, red colorations are obtained with a low film thickness (500 to 1300 nm) and very good contrast (TSUBOSAKA ELECTRIC CO., LTD, Model CT-1), which differ only a little from the hue of samples without additives.

Application examples for color filter applications:

7.2 g of Joncryl 611 (styrene-acrylate resin, Johnson Polymers) are stirred in 13.4 g of PGMEA for one hour and admixed with stirring with a further 42 g of PGMEA, 7.2 g of pigment or pigment preparation, 1.8 g of Solsperse 24000 and 0.36 g of Solsperse 22000 (Avecia). Following the addition of 122 g of zirconium oxide beads (0.5-0.7 mm) the batch is dispersed in the Paint Shaker for two hours. The pigment dispersion is applied using a spincoater (POLOS Wafer Spinner) to glass plates (SCHOTT, laser-cut, 10×10 cm) and the contrast (Goniometer DMS 803, Spectrograph CCD-SPECT2) is measured.

The pigment preparations from examples 1 to 5 are highly suitable for color filter applications on account of their high contrast.

Application examples for transparent baking varnishes:

4 parts of a pigment or pigment preparation from the examples described above are ground in a bead mill for 30 minutes with 96 parts of a mixture of 50 parts of a 60% strength by weight solution of cocoaldehyde melamine resin in butanol, 10 parts of xylene and 10 parts of ethylene glycol monomethyl ether.

The resulting dispersion is applied to a piece of cardboard and after air drying for 30 minutes is baked at 140° C. for 30 minutes. The color strengths of the pigments or pigment preparations prepared in the examples above are reported in the table.

The color strength indicates the number of parts of TiO₂ needed to bring 1 part of chromatic pigment to ⅓ standard depth of color: 1:×TiO₂

(color strength and its measurement are defined in accordance with DIN EN ISO 787-26). As a comparison (color strength 100%, ΔC=ΔH=0) a correspondingly prepared pigment preparation without the pigment dispersant of the invention is used in each case.

| | Color | | |
|---|---|---|---|
| Sample | strength | ΔC | ΔH |
| Example 1 | 109% | −0.04 | 0.08 |
| Example 2 | 113% | 0.82 | −1.29 |
| Example 3 | 112% | 1.14 | 0.43 |
| Example 4 | 114% | 0.04 | −1.85 |

1) A pigment preparation comprising C.I. Pigment Red 254 having an average particle size d₅₀ of 20 to 100 nm and at least one pigment dispersant of the formula (II) (III) or a mixture thereof 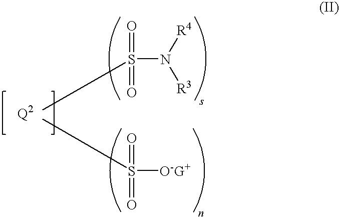
wherein
Q² is the radical of an organic pigment selected from the group consisting of C.I. Pigment Red 264 and C.I. Pigment Violet 19;
s is a number from 1 to 5;
n is a number from 0 to 4, the sum of s and n being 1 to 5;
R³ is a branched or unbranched, saturated or unsaturated, aliphatic hydrocarbon radical having 1 to 20 carbon atoms, a C₅-C₇ cycloalkylene radical, an araliphatic or aromatic radical having 1, 2 or 3 aromatic rings, it being possible for the rings to be fused or to be linked by a bond, or a heterocyclic radical having 1, 2 or 3 rings containing 1, 2, 3 or 4 heteroatoms from the group O, N, S, or a combination thereof; wherein the hydrocarbon, cycloalkylene, aromatic, araliphatic, and heteroaromatic radicals are substituted by 1, 2, 3 or 4 substituents COOR⁵ or SO₃R⁵, with R⁵ being hydrogen, phenyl or C₁-C₆ alkyl;
R⁴ is hydrogen, R³ or C₁-C₆ alkyl-COO⁻E⁺;
E⁺, G⁺ independently of one another are H⁺ or the equivalent M^{p+}/m of a metal cation M^{p+} from main group 1 to 5 or from transition group 1 or 2 or 4 to 8 of the Periodic Table of the Elements, m being one of the numbers 1, 2 or 3 and p being the number 1, 2 or 3; or is a substituted or unsubstituted ammonium ion; 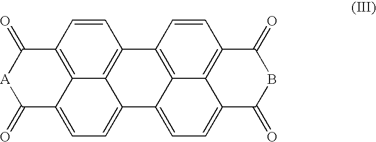
wherein
A is a divalent radical —O—, —NR³— or —NR¹⁶—SO₃⁻G⁺,
B is a divalent radical —NR¹⁶—SO₃⁻G⁺,
R¹⁶ being a linear or branched C₁-C₆ alkylene chain and R³ and G⁺ being as defined above.

2) The pigment preparation as claimed in claim 1, wherein in the compound of the formula (II) s is a number from 1 to 3 and n is a number from 0 to 2.

3) The pigment preparation as claimed in claim 1, wherein the weight ratio of C.I. Pigment Red 254 to the at least one pigment dispersant is between 99.9:0.1 and 80:20.

4) The pigment preparation as claimed in claim 1, wherein the weight ratio of C.I. Pigment Red 254 to the at least one pigment dispersant is between 99:1 and 89:11.

5) The pigment preparation as claimed in claim 1, wherein the pigment preparation has a viscosity of 3 to 50 mPas.

6) The pigment preparation as claimed in claim 1, having a main-peak width at half peak height of 0.2 to 0.7°2theta in the X-ray powder diffractogram with CuKₐₗₚₕₐ radiation.

7) The pigment preparation as claimed in claim 1, wherein ΔH, according to CIELAB, compared with C.I. Pigment Red 254 at ⅓ standard color depth and identical particle size, is not greater than 2.

8) The pigment preparation as claimed in claim 1, wherein ΔC, according to CIELAB, compared with C.I. Pigment Red 254 at ⅓ standard color depth and identical particle size, is not greater than 2.

9) A process for preparing a pigment preparation as claimed in claim 1 comprising the step of admixing C.I. Pigment Red 254 with the at least one pigment dispersant before or during an operation of kneading, wet grinding, dry grinding or finishing.

10) A pigmented high molecular mass organic materials of natural or synthetic origin pigmented with the pigment preparation according to claim 1.

11) A high molecular mass organic material comprising a coloristically effective amount of a pigment preparation as claimed in claim 1.

12) A color filter comprising a coloristically effective amount of a pigment preparation as claimed in claim 1.

13) The pigmented high molecular mass organic materials of natural or synthetic origin as claimed in claim 10, wherein the pigmented high molecular mass organic materials of natural or synthetic origin is selected from the group consisting of plastics, resins, varnishes, paints, electrophotographic toners, electrophotographic developers, electret materials, color filters, inks and printing inks.
